(19) United States
(12) Patent Application Publication
(10) Pub. No.: US 2003/0126005 A1
(43) Pub. Date: Jul. 3, 2003

(54) Method of claiming obsolescence

(76) Inventors: Yi-Ming Liao, Taipei (TW); Cheng-Ju Chen, Taipei (TW)

Correspondence Address: BIRCH STEWART KOLASCH & BIRCH, PO BOX 747, FALLS CHURCH, VA, 22040-0747, US

(21) Appl. No.: 10/032,571

(22) Filed: Jan. 2, 2002

(51) Int. Cl. G06F 17/60

(52) U.S. Cl. 705/10; 705/28

(57) ABSTRACT

A method of claiming obsolescence, especially a claim method owing to production orders below forecast orders. The disclosed method aims at resolving the problem of not being able to process claims of obsolescence in electronic format between enterprises and vendors/suppliers. In the invention, the Enterprise Resource Planning (ERP) server manages and controls the inventory system and transmits data by a configure to order (CTO) concept and method to process centralized management of obsolescent materials, to reduce the risk of purchasing materials by enterprises, and increase profit margins of enterprises.

### BACKGROUND OF THE INVENTION

1. Field of the Invention

The invention relates to a method of managing obsolescent materials, and particularly a method of claiming obsolescence owing to production orders below forecast orders on an inventory management system in the manufacturing industry.

2. Related Art

With most enterprises and product manufacturers there are many ways to increase profit margins, and managing costs is one of the ways. Moreover, management of material costs among cost categories is a matter of interest to enterprises. To satisfy required product quantities of clients or end users, enterprises and product manufacturers have to prepare sufficient materials for maintaining normal processes of productions while receiving production orders. The inability to maintain sufficient stock inventory would suspend operations of production lines, so that finished goods from productions cannot be delivered on time. This may cause the loss of potential commercial opportunities, cause an imbalance between supply and demand, or reduce, even lose, market shares to those enterprises and product manufacturers. On the contrary, overstocking would cause a hoard of cash funds, difficulties in circulating capital and increase in management of costs, and the loss of margin profits from invisible risks of changeable product markets to those enterprises and product manufacturers.

Daily faced problems to the manufacturing industry include: what parts or components need to be purchased, how to plan production schedules after purchasing material items, how to arrange delivery and distribution of finished goods from productions, how to manage excess/surplus stock, etc. For example, capacity forecasts and production orders are not the same thing, and even a production order could possibly be changed without notice. Therefore, loss due to a stock-out or excess/surplus stock results from mistaken list making and incorrect materials preparation. Moreover, current Enterprise Resource Planning (ERP) systems still have the following drawbacks: when forecast orders are greater than production orders there is no stock-out problem in the facility and finished goods produced by facilities could be delivered on time. However, this causes a glut in the stock house/inventory center due to misestimated forecast orders. Moreover, it is too trivial and varied for a manufacturer to put in a claim on a vendor/supplier for obsolescence before completing the process of manually checking each order form. Thus, the vendor/supplier may prevaricate and disregard a claim request, or further appeal the case to a court. All these procedures are time-consuming, cause waste of resources, and increase costs of an enterprise.

Hence, a method of claiming obsolescence in the manufacturing industry has become a heavily focused subject.

### SUMMARY OF THE INVENTION

In view of the foregoing, the invention aims at resolving the preceding disadvantages to provide a method of claiming obsolescence owing to production orders below forecast orders. The primary objects of the invention are to control and manage inventory stock status in facilities through the Enterprise Resource Planning (ERP) server to search produced finished goods, find variant orders and explode bills of material (BOM) of produced finished goods from those variant orders. When obsolescence is confirmed, the enterprise can make a claim for obsolescence on vendors/suppliers. The disclosed invention helps the enterprise to reduce the risk of purchasing materials and decrease the glut of inventory, which increases profit margins.

The disclosed method of claiming obsolescence owing to production orders below forecast orders at least consists of: calculating material part numbers of produced finished goods from those variant orders between a forecast order and a production order through the Enterprise Resource Planning (ERP) server, generating quantities of at least one surplus stock according to those material part numbers of the variant finished goods, calculating required quantity demands of the surplus/excess stock over a fixed time interval to compare with surplus stocks in inventory, and making claim requests on the vendor/supplier ends.

The foregoing, as well as additional objects, features and advantages of the invention will be more readily apparent from the following detailed description, which proceeds with reference to the accompanying drawings. Specific structures and functional details disclosed hereunder are not to be interpreted as limiting, but merely as a basis for the claims and as a representative basis for teaching one skilled in the art to variously employ the invention.

### BRIEF DESCRIPTION OF THE DRAWINGS

FIG. 1 is a schematic representation of the method of claiming obsolescence of the invention.

FIG. 2-a is a flowchart representation of the method of claiming obsolescence of the invention.

FIG. 2-b is a sub-flowchart representation of the method of claiming obsolescence of the invention.

FIG. 2-c is a sub-flowchart representation of the method of claiming obsolescence of the invention.

FIG. 2-d is a sub-flowchart representation of the method of claiming obsolescence of the invention.

### DETAILED DESCRIPTION OF THE INVENTION

This invention proposes a method of claiming obsolescence. In particular, a method targeting production orders lower than forecast orders, based on the advocacy of the up-to-date Business Process Re-Engineer (BPR), mainly aims at improving effective utilization and management of enterprise resources, and re-engineering the working process of managing and claiming obsolescence to decrease the risk of inventory and reduce operation costs of the organization.

Before describing this invention, the meanings of obsolescence are introduced hereunder.

1. Technical obsolescence: a produce has become unvalued owing to out-of-date technology or transformed specifications.

2. Life-cycle obsolescence: a product has become spoiled or moldy due to being stored beyond its expiry date or improper storage conditions.

3. Financial obsolescence : due to long-term storage, products or materials gradually increase maintenance costs, which offset the value of the products or materials.

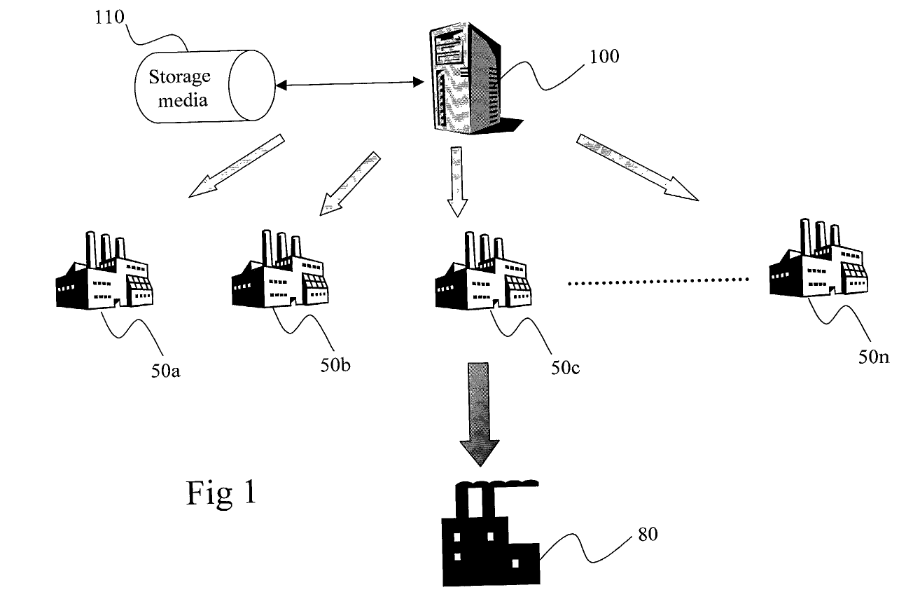

The feasibility and practicality of the invention will be elaborated by means of an embodiment depicted in the following. FIG. 1, which is a schematic representation of the method of claiming obsolescence of the invention is introduced hereunder.

First of all, the Enterprise Resource Planning (ERP) server 100 at the enterprise end integrates and manages all material resources of the enterprise end, and captures stock data from a storage media 110. There are various material stocks and finished goods in different facilities 50a˜n, among which the various finished goods stock between production orders and forecast orders can be analyzed and contrasted with one another. The Enterprise Resource Planning (ERP) server 100 then delivers obsolescent goods to an obsolescence facility 80 for centralized management through the working process of the disclosed invention, and further makes claims for obsolescence on the vendor/supplier ends.

Following the aforementioned, a forecast order A, for example, is an order for the following week predicted by the Enterprise Resource Planning (ERP) server 100, based on build order records of the past from clients. When there are 50 units of product B predicted for production by the forecast order A, and there are only 20 production orders C of the week received by the Enterprise Resource Planning (ERP) server 100, the rest of the materials for 30 units of product B, which have been prepared by the Enterprise Resource Planning (ERP) server 100, might not be used up at the same time. Hence, the Enterprise Resource Planning (ERP) server 100 calculates the life cycle of product B to generate another forecast order D, which is an estimated sum of product B for four months later. Generally, the enterprise end sets a four-month period as the life cycles of all materials. Thus, when there are only 20 units of product B predicted for production within the four-month period by the forecast order D, less than 30 of the above left, the Enterprise Resource Planning (ERP) server 100 explodes bills of material (BOM) of the remaining 10 units for product B to find the specified materials and the common ones. Where the common materials can be used in other ways for general products, the specified materials become obsolescent, which means that the specified materials for the remaining 10 units of product B would be claimed against vendors/suppliers.

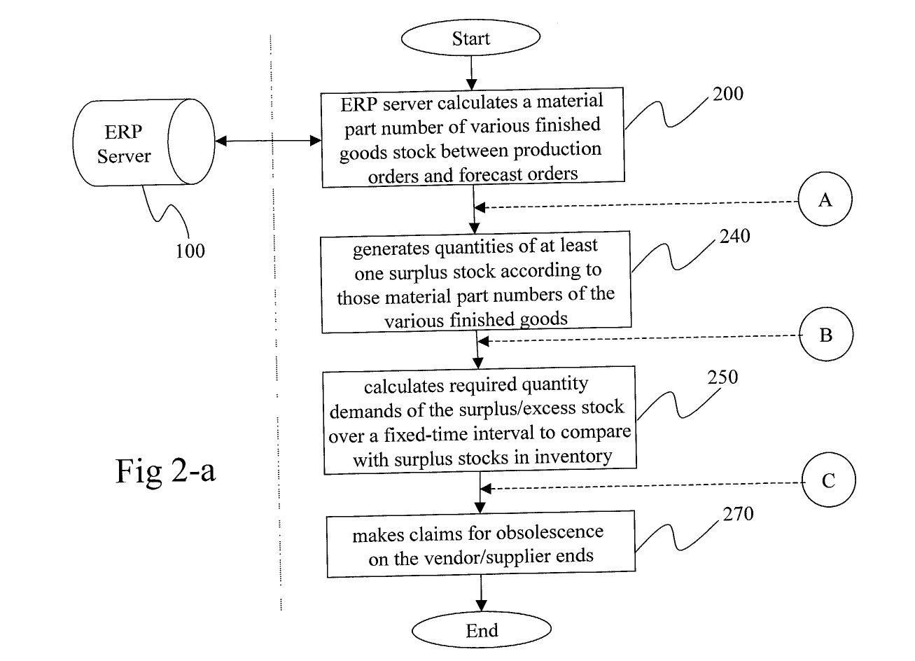

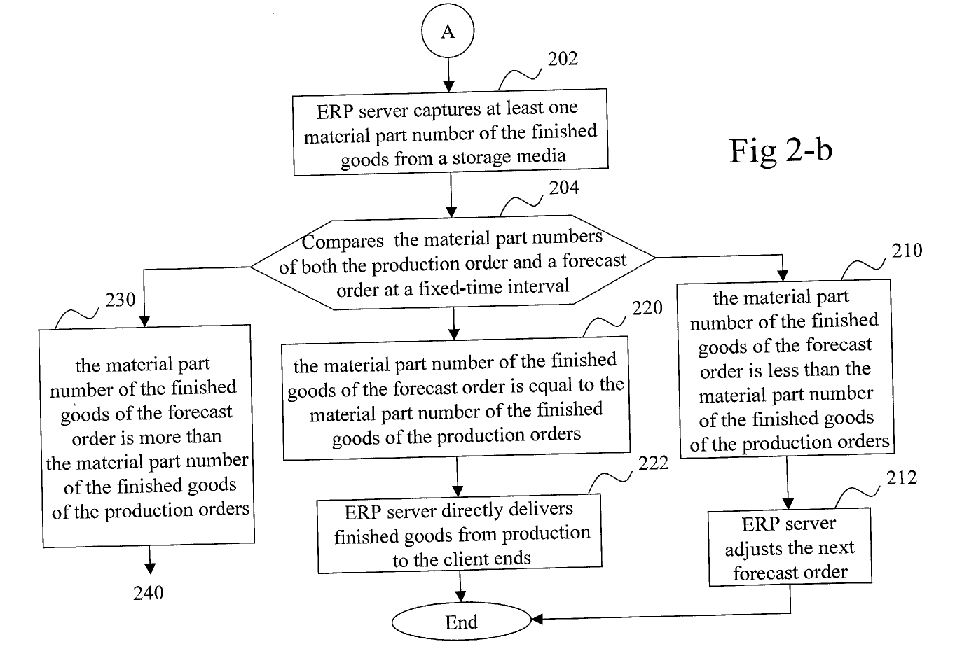

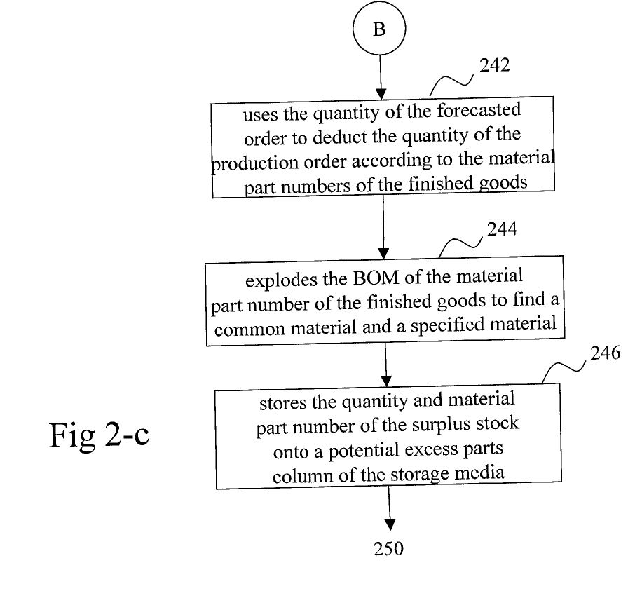

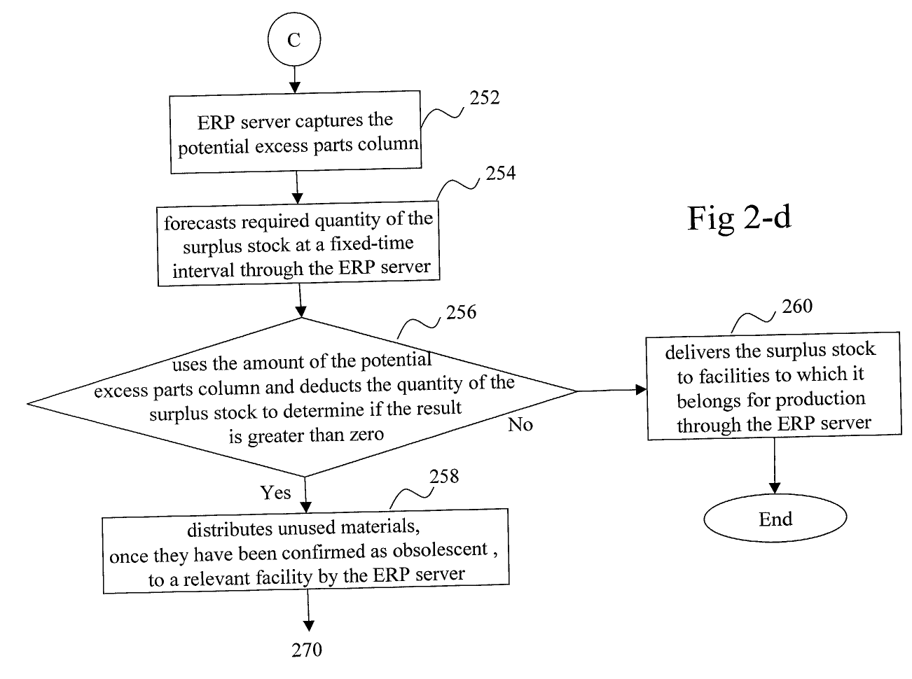

FIGS. 2-a, 2-b, 2-c, and 2-d illustrate the flowchart and sub-flowchart representations of the operation of the invention. Details are provided hereunder.

The Enterprise Resource Planning (ERP) server 100 first calculates a material part number from the difference between a forecast order and a production order (step 200), which relates to the process symbol A. The object is to search the status of material part numbers for all finished goods through the Enterprise Resource Planning (ERP) server 100. As shown in FIG. 2-b of the process symbol A, the Enterprise Resource Planning (ERP) server 100 captures at least one material part number of the finished goods from a storage media 110 (step 202), then compares the material part numbers of both the production order and a forecast order at a fixed time interval (step 204). During the process of comparison, the possible statuses are as follows: the material part number of the finished goods of the forecast order is less than the material part number of the finished goods of the production orders (step 210), the material part number of the finished goods of the forecast order is equal to the material part number of the finished goods of the production orders (step 220), or the material part number of the finished goods of the forecast order is more than the material part number of the finished goods of the production orders (step 230). When the flow goes to step 210, the Enterprise Resource Planning (ERP) server 100 adjusts the next forecast order (step 212). When material part numbers of finished goods on forecast orders predicted through the Enterprise Resource Planning (ERP) server 100 are far less than material part numbers of finished goods on production orders by clients, it means that quantity demands of clients are increasing. Thus, the Enterprise Resource Planning (ERP) server 100 must adjust the following quantities of finished goods to meet clients requirements to avoid stock-outs in inventory during production. The aforementioned fixed-time interval is pre-set by the Enterprise Resource Planning (ERP) server 100 based on various clients' requirements to process integration of orders, and the Enterprise Resource Planning (ERP) server 100 adjusts the amount at this stage. When the flow goes to step 220, the Enterprise Resource Planning (ERP) server 100 directly delivers finished goods from production to the client ends (step 222). When the flow goes to step 230, the Enterprise Resource Planning (ERP) server 100 makes a mark on the material part number of the finished goods, as marked materials could possibly become obsolescent . When the process symbol A is finished, the flow goes to FIG. 2-a. The Enterprise Resource Planning (ERP) server 100 then calculates the amount of at least one surplus/excess material according to the variant material part numbers of the finished goods (step 240), which relates to the process symbol B. As shown in FIG. 2-c of the process symbol B, the Enterprise Resource Planning (ERP) server 100 uses the quantity of the forecasted order to deduct the quantity of the production order according to the material part numbers of the finished goods (step 242) to generate the amount of surplus stock. The Enterprise Resource Planning (ERP) server 100 explodes the bill of material (BOM) of the material part number of the finished goods to find a common material and a specified material (step 244), then stores the quantity amount and material part number of the surplus stock onto a potential excess parts column of the storage media (step 246). When the process symbol B is finished, the flow then returns to FIG. 2-a. The Enterprise Resource Planning (ERP) server 100 calculates the quantity demands of the surplus stock over a fixed-time interval to compare with surplus stock in inventory (step 250). This fixed time interval is pre-set by the Enterprise Resource Planning (ERP) server 100 based on life cycles of materials of various types. The comparison process relates to the process symbol C. According to FIG. 2-d of the process symbol C, the Enterprise Resource Planning (ERP) server 100 captures the potential excess parts column (step 252) and forecasts the required quantity of the surplus stock at a fixed time interval (step 254) through the Enterprise Resource Planning (ERP) server 100. The Enterprise Resource Planning (ERP) server 100 then uses the amount in the potential excess parts column and deducts the quantity of the surplus stock to determine if the result is greater than zero (step 256). If it is not, the surplus stock is delivered to the facilities 50 to which it belongs for production through the Enterprise Resource Planning (ERP) server 100 (step 260). At the same time, the Enterprise Resource Planning (ERP) server 100 marks those material part numbers (common materials and specified materials) for finished goods. If the result is greater than zero , unused materials become obsolescent and are distributed to the relevant facility 50 once confirmed by the Enterprise Resource Planning (ERP) server 100 (step 258). The flow then goes back to FIG. 2-a, and the Enterprise Resource Planning (ERP) server 100 makes a claim on vendors/suppliers (step 270) for those materials that are confirmed to be obsolescent . The flow is, therefore, ended.

The respective meanings of the aforementioned forecast order 10 and production order 20 are: a forecast order 10 is generated through the Enterprise Resource Planning (ERP) server 100 based on procurement records provided by a vendor/supplier end to forecast the replenishment of quantities and categories of required materials at a predetermined interval by the enterprise end; whereas a production order 20 relates to a build order placed by a client end at a predetermined interval.

The meanings of specific materials and common materials are: the specific materials are specified components or parts needed for respective prototypes/modules, no components and parts among which are overlapped in common; the common materials relate to general components or parts needed for at least two prototypes/modules and above, and are evaluated by pre-set columns through the Enterprise Resource Planning (ERP) server.

The aforementioned a facility 50 is to distinguish production demands according to various product prototypes/modules, and to implement received build orders at the enterprise end; whereas an obsolescence facility 80 is to manage obsolescent materials and to centrally make claims to vendors.

The invention further utilizes a special data transfer method to setup customized fields and formats according to different requirements of vendors to achieve the object of transmitting data by using a configure to order (CTO) concept. The aforementioned method is to place conventional data transfer concepts and architecture on the Web. It mainly employs the techniques of Enterprise Resource Planning (ERP), Supply Chain Management (SCM), and Information Intermediary to achieve the functions of integrating diverse data and instantly transferring data . It can be used between the suppliers and enterprise end in the supply chain for the suppliers to receive data actively, and to transfer effective information directly according to users' requirements. In the mean time, it can also process in reverse by sending effective information from the suppliers to the enterprise end. It further establishes a data transfer unit at a third-party authenticator between the supplier ends and enterprise end to facilitate data transfer.

As mentioned above, the function and processes provided by the information intermediary have the same format, and cannot offer different fields and formats required by different vendors/suppliers. Hence, the information intermediary cannot fully attain its effectiveness. The invention offers a data transfer mode to resolve this problem. By using a Configure to Order (CTO) concept, in addition to transmitting data on the network, it also can setup different fields and formats according to different requirements so that suppliers can receive and deliver materials more efficiently and easily.

The invention in the form of a method for claiming obsolescence is disclosed herein. These and other variations, which will be understood by those skilled in the art, are within the intended scope of the invention as claimed below. As previously stated, detailed embodiments of the invention are disclosed herein; however, it is to be understood that the disclosed embodiments are merely exemplary of the invention that may be embodied in various forms.

What is claimed is:

1. A claim for obsolescence method relates to a claim method targeting production orders are less than forecast orders on a inventory management system in the manufacturing industry. Through the Enterprise Resource Planning (ERP) server at an enterprise end, the method is to achieve the objects of managing required products by clients, utilizing configure to order (CTO) concept of transmitting data to timely control life cycles of materials and to decrease the risk of a hoard of inventory. The disclosed method includes at least the following steps:
Calculating material part numbers of produced finished goods from those variant orders between a forecast order and a production order through the Enterprise Resource Planning (ERP) server;
Generating quantities of at least one surplus stock according to those material part numbers of the variant finished goods;
Calculating required quantity demands of the surplus/excess stock over a fixed time interval to compare with surplus stocks in inventory; and
Making for claim requests on the vendor/supplier ends.

2. The invention as recited in claim 1, wherein the forecast order is generated through the Enterprise Resource Planning (ERP) server based on procurement records provided by the vendor/suppler end to forecast required replenishment of quantities and material categories at the enterprise end at a predetermined interval.

3. The invention as recited in claim 1, wherein the production order relates to a build order placed by the client end at a predetermined interval.

4. The invention as recited in claim 1, wherein the step of calculating material part numbers of produced finished goods from those variant orders between a forecast order and a production order through the Enterprise Resource Planning (ERP) server further comprises steps of the following:
Capturing at least one material part number of the finished goods from a storage media through the Enterprise Resource Planning (ERP) server;
Contrasting the material part numbers of both the production order and a forecast order at a fixed time interval; and
Determining if the material part number of the finished goods of the forecast order is more than the material part number of the finished goods of the production orders.

5. The invention as recited in claim 1, wherein the step of calculating material part numbers of produced finished goods from those variant orders between a forecast order and a production order through the Enterprise Resource Planning (ERP) server further comprises steps of the following:
Determining if the material part number of the finished goods of the forecast order is less than the material part number of the finished goods of the production orders; and
Adjusting the next forecast order through the Enterprise Resource Planning (ERP) server.

6. The invention as recited in claim 4, wherein a fixed time interval is pre-set by the Enterprise Resource Planning (ERP) server based on various clients' requirements.

7. The invention as recited in claim 1, wherein the step of calculating material part numbers of produced finished goods from those variant orders between a forecast order and a production order through the Enterprise Resource Planning (ERP) server further comprises steps of the following:
Using the quantity amount of the forecasted order to deduct the quantity amount of the production order according to the material part numbers of the finished goods through the Enterprise Resource Planning (ERP) server;
Exploding bill of material (BOM) of the material part number of the finished goods to find a common material and a specified material; and
Storing the quantity amount and material part number of the surplus stock onto a potential excess parts column of the storage media.

8. The invention as recited in claim 7, wherein the specific materials are specified components or parts needed for respective prototypes/modules, no components and parts among which are overlapped in common.

9. The invention as recited in claim 7, wherein the common materials relate to general components or parts needed for at least two prototypes/modules and above, and are evaluated by pre-set columns through the Enterprise Resource Planning (ERP) server.

10. The invention as recited in claim 1, wherein the step of calculating required quantity demands of the surplus/excess stock over a fixed time interval to compare with surplus stocks in inventory further comprises the steps of the following:
Capturing a potential excess parts column through the Enterprise Resource Planning (ERP) server;
Forecasting required quantity of the surplus stock at a fixed time interval through the Enterprise Resource Planning (ERP) server;
Using the amount of the potential excess parts column deducts quantity of the surplus stock to determine if the result is greater than zero; and
Distributing unused materials, if confirmed to be obsolescence, to relevant facility.

11. The invention as recited in claim 10, wherein the fixed time interval is pre-set by the Enterprise Resource Planning (ERP) server based on life cycles of materials of various material features.

12. The invention as recited in claim 10, wherein the facility is to distinguish production demands according to various product prototypes/modules, and to implement received build orders at the enterprise end.

13. The invention as recited in claim 1, wherein the method of utilizing configure to order (CTO) concept of transmitting data is to transmit data on the network, it also can setup different fields and formats according to different requirements from various clients.
